(19) United States
(12) Patent Application Publication
(10) Pub. No.: US 2010/0241997 A1
(43) Pub. Date: Sep. 23, 2010

(54) DISPLAY DEVICE

(75) Inventor: Satoru Arakane, Nagoya-shi (JP)

Correspondence Address: Scully, Scott, Murphy & Presser, P.C., 400 Garden City Plaza, Suite 300, Garden City, NY, 11530, US

(73) Assignee: BROTHER KOGYO KABUSHIKI KAISHA, Aichi-ken (JP)

(21) Appl. No.: 12/725,783

(22) Filed: Mar. 17, 2010

(30) Foreign Application Priority Data
Mar. 17, 2009 (JP) 2009-064075
Mar. 17, 2009 (JP) 2009-064079

(51) Int. Cl. G06F 3/048

(52) U.S. Cl. 715/854

(57) ABSTRACT

In a display device, the display unit includes a first portion and a second portion. The display control unit changes a screen image to display from one to another of the plurality of screen images along a screen navigation path starting from the base screen image. The navigation string generating unit generates a navigation string including the title strings each corresponding to a screen image which is positioned in a part of the screen navigation path from the base screen image to a current screen image that is displayed on the first portion currently. The navigation string display unit controls the display unit to display the navigation string in the second portion. When the first determining unit determines that a title string is selected, the selected screen display unit controls the display unit to display a screen image specified by the selected title string in the first portion.

### CROSS REFERENCE TO RELATED APPLICATION

This application claims priority from Japanese Patent Application No. 2009-064079 filed Mar. 17, 2009, and Japanese Patent Application No. 2009-064075 filed Mar. 17, 2009. The entire contents of the priority applications are incorporated herein by references.

### TECHNICAL FIELD

The present invention relates to a display device.

### BACKGROUND

A display device well known in the art displays setting contents for executing a desired operation of a target device. A multifunction peripheral, as an example of a display device, displays a setup menu screen in a display panel provided on the multifunction peripheral. The menu screen includes various choices for each function of the multifunction peripheral, such as facsimile setup and scanner setup, as well as a general setup selection. When the user selects one of the choices listed in the menu, the multifunction peripheral changes the display on the display panel to a list of setting items related to the selected function.

When the user selects one of the setting items from the displayed list, the multifunction peripheral changes the display on the display panel to a modification screen in which the user can modify the value assigned to the setting item. While the modification screen is displayed, the user may input or modify the value assigned to the setting item as desired.

As the user performs operations to navigate through the prepared screens in this way, data indicating the path that the user has taken to arrive at the current screen may also be displayed in the display panel together with the current screen. One conventional format for displaying this path is called “breadcrumbs.”

Breadcrumbs (or “breadcrumb trail”) is a format for displaying the name of each screen that the user has navigated through to arrive at the current screen in the order displayed, such as in the example “Menu screen>Facsimile setup>Resolution.” Through the breadcrumbs displayed with each screen, the user can determine to which function and to which setting item the current screen is related.

### SUMMARY

In view of the foregoing, it is an object of the invention to provide a display device capable of changing a desired screen with simple operation by effectively using data indicating a path that a user has taken.

In order to attain the above and other objects, the invention provides a display device. The display device includes a display unit, a display control unit, a storing unit, a navigation string generating unit, a first navigation string display unit, a first determining unit, and a selected screen display unit. The display unit includes a first portion and a second portion. The display control unit is configured to display one of a plurality of screen images on the first portion, the plurality of screen images including a base screen image and being arranged hierarchically from the base screen image. The display control unit changes a screen image to display from one to another of the plurality of screen images along a screen navigation path starting from the base screen image based on screen navigation data. The screen navigation data indicates relationships between the screen images. The storing unit stores a plurality of title strings, each title string indicating one of the plurality of screen images. The navigation string generating unit is configured to generate a navigation string including the title strings each corresponding to a screen image which is positioned in a part of the screen navigation path from the base screen image to a current screen image that is displayed on the first portion currently. The first navigation string display unit that is configured to control the display unit to display the navigation string in the second portion. The first determining unit is configured to determine whether any title string included in the navigation string displayed in the second portion is selected. When the first determining unit determines that a title string is selected, the selected screen display unit is configured to control the display unit to display a screen image specified by the selected title string in the first portion.

### BRIEF DESCRIPTION OF THE DRAWINGS

The particular features and advantages of the invention as well as other objects will become apparent from the following description taken in connection with the accompanying drawings, in which:

FIG. 1 is a block diagram showing an electrical structure of an MFP according to a first embodiment;

FIG. 2 shows a sample configuration of a screen management table;

FIG. 3(a) is an image showing a menu screen including breadcrumbs displayed in an LCD panel of an LCD;

FIG. 3(b) is an image showing the menu screen including breadcrumbs after a leading omission symbol shown in FIG. 3(a) is pressed;

FIG. 3(c) is an image showing the menu screen including breadcrumbs after a leading omission symbol shown in FIG. 3(b) is pressed;

FIG. 3(d) is an image showing the menu screen after a screen title “Network” shown in FIG. 3(b) is pressed;

FIG. 4 is a flowchart illustrating a part of setup screen display process;

FIG. 5 is a flowchart illustrating a part of setup screen display process that succeeds the process shown in FIG. 4;

FIG. 6 is a flowchart illustrating a part of setup screen display process that succeeds the process shown in FIG. 5;

FIG. 7 is a flowchart illustrating a part of setup screen display process that succeeds the process shown in FIG. 6;

FIG. 8 is a flowchart illustrating a part of setup screen display process that succeeds the process shown in FIG. 6;

FIG. 9(a) is an image showing a menu screen including breadcrumbs displayed in an LCD panel according to a second embodiment;

FIG. 9(b) is an image showing the menu screen including breadcrumbs after a leading omission symbol shown in FIG. 9(a) is pressed;

FIG. 10 is a flowchart illustrating a part of setup screen display process according to the second embodiment;

FIG. 11 is a flowchart illustrating a part of setup screen display process according to the second embodiment;

FIG. 12(a) is an image showing a menu screen including breadcrumbs displayed in the LCD panel according to a third embodiment;

FIG. 12(b) is an image showing the menu screen including breadcrumbs after a leading omission symbol shown in FIG. 12(a) is pressed;

FIG. 12(c) is an image showing the menu screen including breadcrumbs after a trailing omission symbol shown in FIG. 12(b) is pressed;

FIG. 13 is a flowchart illustrating a part of setup screen display process according to the third embodiment;

FIG. 14(a) is an image showing a menu screen including breadcrumbs displayed in the LCD panel according to a fourth embodiment;

FIG. 14(b) is an image showing the menu screen including breadcrumbs after a leading omission symbol shown in FIG. 14(a) is pressed;

FIG. 14(c) is an image showing the menu screen including breadcrumbs after a Leading Side button shown in FIG. 14(b) is pressed; and

FIG. 15 is a flowchart illustrating a part of setup screen display process according to the fourth embodiment.

### DETAILED DESCRIPTION

A multifunction peripheral 1 (hereinafter referred as MFP 1) according to embodiments of the invention will be described while referring to the accompanying drawings wherein like parts and components are designated by the same reference numerals to avoid duplicating description.

### First Embodiment

The MFP 1 is a multifunction peripheral having multiple functions, including a facsimile function and printer function. The MFP 1 also allows the user to modify various setting items defining operating conditions and the like for each function. The MFP 1 can display one of a plurality of prepared setup screens that allow the user to modify values for each setting item. The setup screens are displayed on a liquid crystal display (LCD) 16 in sequences following predetermined screen navigation paths.

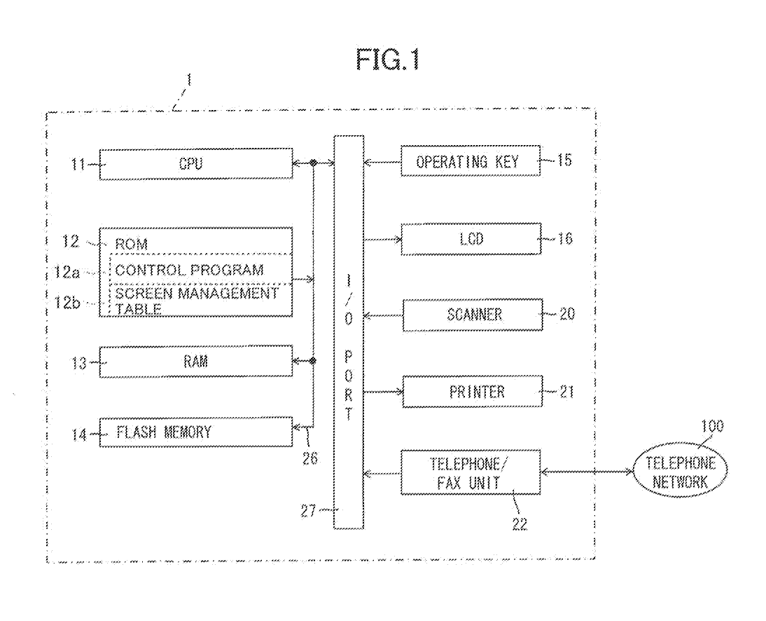

FIG. 1 is a block diagram showing the electrical structure of the MFP 1. The MFP 1 is provided with a CPU 11, a ROM 12, a RAM 13, a flash memory 14, operating keys 15, the LCD 16, a scanner 20, a printer 21, and a telephone/fax unit 22.

The CPU 11, the ROM 12, the RAM 13, and the flash memory 14 are interconnected via a bus line 26. The bus line 26 is connected to the input output port (I/O port) 27. The operating keys 15, the LCD 16, an scanner 20, the printer 21, and the telephone/fax unit 22 are connected to the I/O port 27. The telephone/fax unit 22 is connected to a telephone network 100. The MFP 1 includes other components, such as an interface for connecting to a personal computer or LAN, but these components are not shown in the drawings and will not be described herein.

The CPU 11 serves to control each device connected to the I/O port 27. The ROM 12 is a read only memory storing a control program 12a executed on the MFP 1 and a screen management table 12b. The CPU 11 executes processes shown in flowcharts described later according to the control program 12a.

The RAM 13 is for temporarily storing various data. The flash memory 14 is a nonvolatile rewritable memory for storing setting items, setting contents, and fixed values and for retaining the setting items, the setting contents, and the fixed values after turning off the MPF 1.

The operating keys 15 are operated by a user to select functions of the MFP 1 and to change the display on the LCD 16. The LCD 16 has an LCD panel (not shown) that functions as a touch panel. The MFP 1 displays prepared screens on the LCD panel as needed.

With this configuration, the MFP 1 can be switched to one of a plurality of modes, including a print mode for executing printing operations, a facsimile mode for receiving and transmitting facsimiles, and a setup mode for modifying values of various setting items, based on user operations via the operating keys 15.

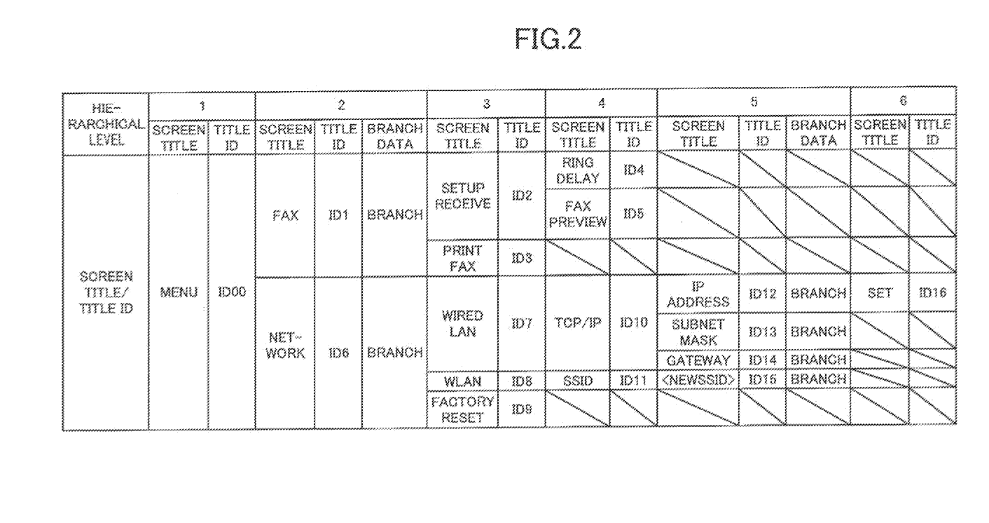

FIG. 2 shows a sample configuration of the screen management table 12b. The screen management table 12b defines a hierarchical level, a screen title, a title ID, and branch data for each of the prepared screens that can be displayed in the LCD panel of the LCD 16.

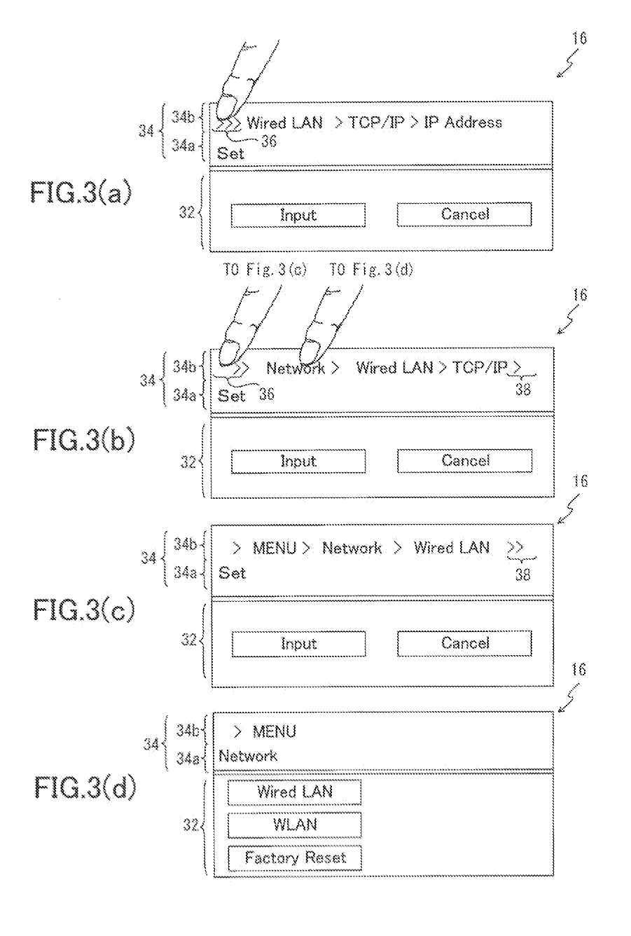

The hierarchical level is a value indicating the hierarchical position to which the screen belongs. In the example shown in FIG. 2, each of the screens belongs to one of first through sixth levels. The screen title is configured of a descriptive character string by which the content of the screen can be discerned. One screen title is uniquely assigned to each screen. As will be described later with reference to FIG. 3(a), this screen title is displayed in the LCD panel together with the corresponding screen. The title ID is a resource ID in the form of a character string. One unique title ID is assigned to each screen title and is used to create a breadcrumbs, as will be described later. The branch data indicates that one screen constitutes a branch with another screen within the same hierarchical level. That is, in the screen management table 12b, each level includes the screen title and the title ID in association with the screen title. If a screen title is assigned with the branch data, for example, the LCD 16 displays decision branch to be selected in a screen corresponding to a screen title assigned with a hierarchical level one level higher than a hierarchical level of a screen constituting a branch. While not described in the first to third embodiments, the branch data will be used in the fourth embodiment described later. Thus, in the first to third embodiments, the screen management table 12b may not include the branch data,

Of the various screens that have been prepared for displaying in the LCD panel of the LCD 16, the description in the embodiment will particularly focus on screens displayed when a setup mode has been selected. In addition, the hierarchical level, the screen title, and the title ID for each screen are prestored in the screen management table 12b during the manufacturing stage of the MFP 1.

The MFP 1 transitions from the top hierarchical level to each lower level in sequence. For example, in order to display a set screen belonging to the sixth level, the MFP 1 first displays a menu screen (having the screen title “MENU”) of the first level, then displays a network setup screen (having the screen title “Network”) of the second level, then displays a wired LAN setup screen (having the screen title “Wired LAN”) of the third level, then displays a TCP/IP screen of the fourth level, then displays an IP address screen of the fifth level, and finally displays the set screen of the sixth level.

Here, the screens displayed on the LCD 16 will be described with reference to FIGS. 3(a)-3(d). FIG. 3(a) is an image showing the menu screen displayed in the LCD panel of the LCD 16. The display area of the LCD panel is configured of a selection display area 32, and a screen description area 34 having a title display area 34a and a breadcrumbs display area 34b. The screen title of the currently displayed screen is displayed in the title display area 34a. Possible succeeding screens are displayed in the selection display area 32,

FIGS. 3(a)-3(d) show sample screens displayed in the LCD panel when the breadcrumbs are “>Menu>Network>Wired LAN>TCP/IP>IP address.” Here, the breadcrumbs (or “breadcrumb trail”) is a format for displaying the name of each screen that the user has navigated through to arrive at the current screen in the order displayed. The “>” symbol in the breadcrumbs is a separating character and is disposed at the head of each screen title (a character string) included in the breadcrumbs.

When the user inputs a command to enter the setup mode by operating prescribed operating keys 15, the MFP 1 displays a character string representing the menu screen in the title display area 34a of the LCD panel, and displays a list of all possible succeeding screens as choices in the selection display area 32. Next, the user performs an operation to select one of the choices displayed in the selection display area 32. For example, if the user wishes to modify setting values related to the network function, the user performs an operation to select the choice “Network” from among the possible choices “Fax” and “Network” displayed in the selection display area 32. In response, the MFP 1 changes the display on the LCD 16 to the screen corresponding to the user's selection.

FIG. 3(a) shows an example in which the above procedure has been performed to select screens leading to the set screen belonging to the sixth level. In this case, since the entire character string constituting the breadcrumbs cannot be displayed in the breadcrumbs display area 34b, “Menu” and “Network” have been omitted when displaying the breadcrumbs in FIG. 3(a). However, the user can discern that the strings “Menu” and “Network” have been excluded based on a leading omission symbol 36 “>>>” configured of consecutive separating characters and displayed at the head of the breadcrumbs.

In the example of FIG. 3(a), the screen title “Set” for the currently displayed screen is displayed in the title display area 34a, while the choices “Input” and “Cancel” are displayed in the selection display area 32 as possible succeeding screens to the set screen.

In this way, the MFP 1 of the embodiment can display breadcrumbs in the breadcrumbs display area 34b from the screen title for the menu screen belonging to the topmost level of the screen management table 12b to the screen title for the screen one level higher than the screen currently displayed in the title display area 34a.

If the user selects (presses) the leading omission symbol 36 in the LCD panel shown in FIG. 3(a), the MFP 1 adds, in the breadcrumbs display area 34b, the screen title “Network” corresponding to the screen positioned one level higher than the screen title “Wired LAN,” which is the topmost screen title displayed in the breadcrumbs display area 34b in FIG. 3(a), and omits the screen title “IP address” displayed last in the breadcrumbs display area 34b from the display, as illustrated in FIG. 3(b). Hence, by pressing the leading omission symbol 36, the user can confirm the screen title having the lowest hierarchical level among the omitted screen titles. In this way, the MFP 1 can reliably display data that the user requires with greater frequency. When displaying the screen title “Network” in the breadcrumbs display area 34b, the MFP 1 modifies the leading omission symbol 36 to the display “>>” to indicate that only the screen title “Menu” is excluded. Further, when omitting the screen title “IP address” from the breadcrumbs display area 34b, the MFP 1 also adds a trailing omission symbol 38 “>” to the end of the breadcrumbs display area 34b to indicate the exclusion of this screen title.

If the user again presses the leading omission symbol 36 in the LCD panel shown in FIG. 3(b), the MFP 1 adds, in the breadcrumbs display area 34b, the screen title “Menu” corresponding to the screen one level higher than the screen title “Network,” which is currently the topmost screen title displayed in the breadcrumbs display area 34b, and excludes, from the breadcrumbs display area 34b, the screen title “TCP/IP,” which is the lowest level of the currently displayed screen titles, as shown in FIG. 3(c). While displaying the screen title “Menu,” the MFP 1 also removes the leading omission symbol 36 from the display. Further, when removing the screen title “TCP/IP,” the MFP 1 also changes the trailing omission symbol 38 to the display “>>”.

When the user presses the trailing omission symbol 38 in the LCD panel shown in FIG. 3(c), the display in the LCD 16 changes back to the state shown in FIG. 3(b). If the user again presses the trailing omission symbol 38 in the LCD panel shown in FIG. 3(b), the display in the LCD 16 changes back to the state shown in FIG. 3(a). Hence, by pressing the trailing omission symbol 38, the user can confirm the screen title in the topmost position among the omitted screen titles.

If the user presses on the screen title “Network” in the LCD panel shown in FIG. 3(b), the MFP 1 displays the screen title “Network” in the title display area 34a and displays the choices “Wired LAN,” “WLAN,” and “Factory reset” as possible succeeding screens to the network screen in the selection display area 32, as shown in FIG. 3(d). At this time, only the screen title “Menu,” which is the screen one hierarchical level higher than the network screen, is displayed in the breadcrumbs display area 34b. Accordingly, the user can tell at a glance the position of the pressed screen title in the breadcrumbs,

Further, by pressing on a screen title displayed in the breadcrumbs display area 34b, the user can display possible choices for succeeding screens to the pressed screen title in the selection display area 32. By effectively using the breadcrumbs in this way, the user can display desired succeeding screens through a simple operation, unlike a method that requires the user to perform tedious operations for navigating to the desired screen one hierarchical level at a time (returning one screen at a time).

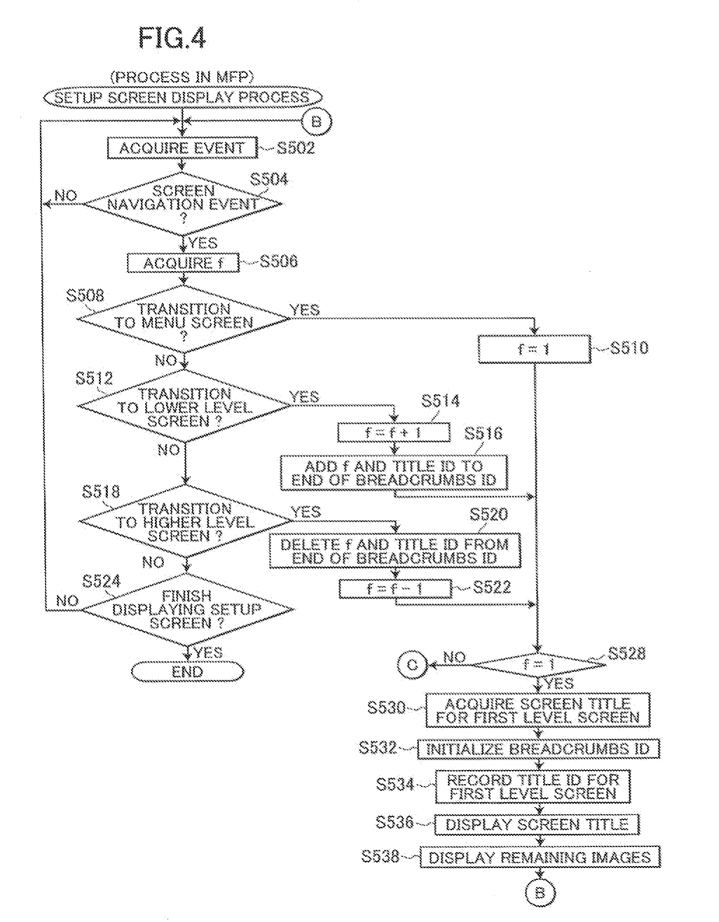

Next, a setup screen display process executed by the CPU 11 of the MFP 1 to implement the display changes illustrated in FIGS. 3(a)-3(d) will be described with reference to FIGS. 4 through 8. The MFP 1 periodically executes the setup screen display process when in the setup mode.

As shown in FIG. 4, in S502 at the beginning of the setup screen display process, the CPU 11 attempts to acquire an event. In S504 the CPU 11 determines whether the acquired event is a screen navigation event. If not (S504: NO), the CPU 11 repeats the process in S502.

However, if so (S504: YES), in S506 the CPU 11 acquires a hierarchical level f for a screen corresponding to a screen title currently displayed in the title display area 34a. In S508 the CPU 11 determines whether the screen navigation event acquired in S502 indicates a transition to the menu screen. For example, if the user performs a prescribed operation on the operating keys 15 to return to the menu screen having a screen title located displayed at the head of the breadcrumbs (S508: YES), then the CPU 11 proceeds to S510, sets the hierarchical level f to 1, and advances to S528.

However, if the CPU 11 determines that the screen navigation event does not correspond to a transition to the menu screen (S508: NO), in S512 the CPU 11 determines whether the screen navigation event indicates a transition to a lower level screen. A positive determination is made in S512 (S512: YES) if, for example, the user chooses a selection displayed in the selection display area 32. Then in S514 the CPU 11 increments the hierarchical level f by “1”, in S516 adds, to the end of a breadcrumbs ID, the hierarchical level f and the title ID for a destination screen to which the display transits (the lower level screen in this case).

Here, the breadcrumbs ID will be described. The breadcrumbs ID is configured of hierarchical levels and title IDs for screens from the menu screen to a screen having the screen title that is currently displayed in the title display area 34a, and indicates the screen navigation path leading to the currently displayed screen. This breadcrumbs ID is stored in the RAM 13 and is updated each time the screen changes, and a breadcrumbs is created based on the breadcrumbs ID. For example, if the current screen is the IP Address screen positioned in the fifth level in the screen management table 12b, the following data is saved as the breadcrumbs ID: [1]ID0[2]ID6[3]1D7[4]ID10[5]ID12, where the number in the “[]” corresponds to the hierarchical level, and each character string starting with “ID” is a title ID. Also, the screen navigation path from the menu screen to the current screen is indicated in the breadcrumbs as “>Menu>Network>Wired LAN>TCP/IP.”

For example, if the acquired event indicates a transition to a lower level screen (S512: YES), the screen will be changed to a screen located in the next lower hierarchical level. Accordingly, the hierarchical level and the title ID of the destination screen (the lower level screen) are added to the end of the breadcrumbs ID. As a result, the following data is saved as the breadcrumbs ID, for example: [1]ID0[2]ID6[3]ID7[4]ID10[5]ID12[6]ID16.

However, if the acquired screen navigation event is not a transition to a lower level screen (S512: NO), in S518 the CPU 11 determines whether the screen navigation event indicates a transition to a higher level screen. When, for example, the user operates the operating keys 15 in a prescribed manner, the CPU 11 determines that the screen navigation event indicates a transition to a higher level screen (S518: YES). After the CPU 11 determines that the screen navigation event indicates a transition to a higher level screen (S518: YES), in S520 the CPU 11 deletes the hierarchical level of f and the title ID of the screen corresponding to the hierarchical level f (i.e., the title ID of the current screen) from the end of the breadcrumbs ID, and in S522 decrements the hierarchical level f by “1”.

In S528 the CPU 11 determines whether the hierarchical level f is “1”.

If f=1 (S528: YES), in S530 the CPU 11 acquires the screen title for the screen in the first level (i.e., the screen title for the menu screen, or “Menu”) from the screen management table 12b.

In S532 the CPU 11 initializes the breadcrumbs ID. In S534 the CPU 11 records the title ID for the first level screen as the breadcrumbs ID in the RAM 13. In S536 the CPU 11 displays the screen title acquired in S530 in the title display area 34a. In S538 the CPU 11 displays (renders) images in regions other than the screen description area 34. Specifically, the CPU 11 displays images in the selection display area 32. Subsequently, the CPU 11 returns to S502.

On the other hand, when in S518 the CPU 11 determines the screen navigation event does not indicate a transition to a higher level screen (S518: NO), in S524 the CPU 11 determines whether the acquired screen navigation event indicates to finish displaying the setup screen. When, for example, an instruction to change from the setup mode to a mode other than the setup mode is inputted, the CPU 11 determines that the acquired screen navigation event indicates to finish displaying the setup screen (S524: YES). In this case, the CPU 11 ends the setup screen display process. On the other hand, when the CPU 11 determines that the acquired screen navigation event does not indicate to finish displaying the setup screen (S524: NO), the CPU 11 returns to S502.

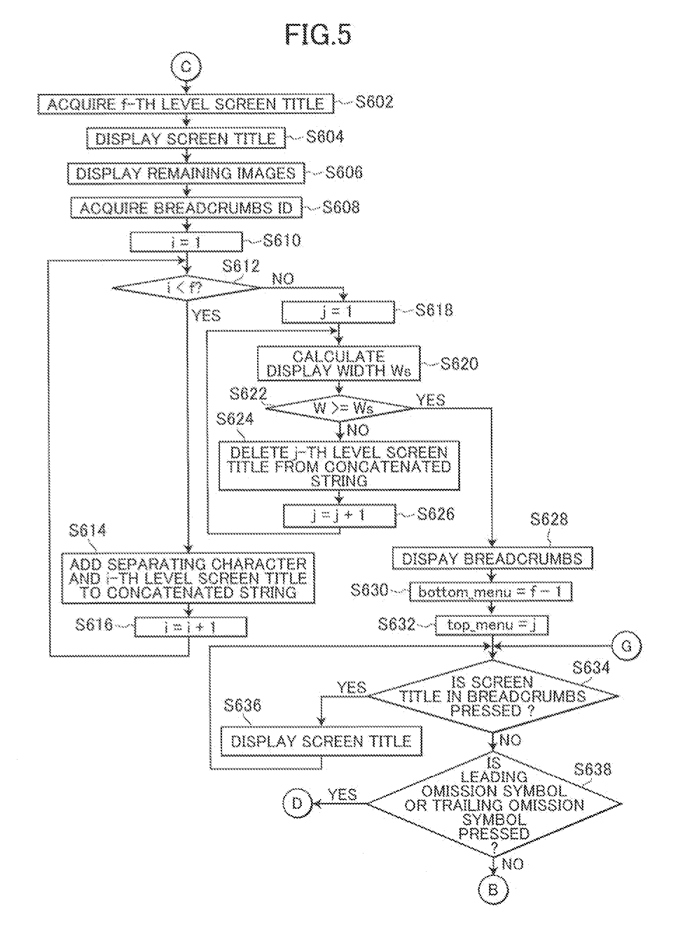

However, if the CPU 11 determines in S528 that f≠1 (S528: NO), in S602 shown in FIG. 5 the CPU 11 acquires, from the screen management table 12b, the screen title for the f^{th} level, i.e., the screen title of the destination screen. In S604 the CPU 11 displays the acquired screen title in the title display area 34a. In S606 the CPU 11 displays (renders) images in regions other than the screen description area 34. More concretely, the CPU 11 displays the destination screen in the selection display area 32. In other words, when the user operation indicates a transition to an upper level screen, the CPU 11 navigates to the next screen in the screen navigation path in a direction toward the menu screen (i.e., toward a smaller numbered hierarchical level). On the other hand, when the user operation indicates a transition to a lower level screen, the CPU 11 navigates to the next screen in the screen navigation path in a direction away from the menu screen (i.e., toward a larger numbered hierarchical level).

In S608 the CPU 11 acquires the breadcrumbs ID from the RAM 13 and thereafter creates a string of screen titles concatenated in order of increasing the number of hierarchical level based on the breadcrumbs ID (hereinafter, referred as a concatenated string).

Specifically, in S610 the CPU 11 sets a variable i to “1” and in S612 determines whether the variable i is smaller than the hierarchical level f. If i<f (S612: YES), in S614 the CPU 11 adds the separating character and the screen title to a concatenated string. More specifically, the CPU 11 reads the title ID for the i^{th} level stored in the breadcrumbs ID, acquires the screen title corresponding to the title ID from the screen management table 12b, and adds this screen title with the separating character positioned at the head thereof to the end of the concatenated string.

In S616 the CPU 11 increments the variable i by “1” and subsequently returns to S612 to repeat the process described above. By repeatedly performing the process in S614, the CPU 11 can create a concatenated string that includes the screen title of all screens positioned along the screen navigation path from the menu screen to a screen whose hierarchical level is one level higher than the hierarchical level of the currently displayed screen, with a separating character inserted between each pair of adjacent screen titles.

When the CPU 11 determines in S612 that i is greater than or equal to the hierarchical level f (S612: NO), in S618 the CPU 11 sets a variable j to “1”, in S639 rasterizes the concatenated string created above, and in S620 calculates a display width Ws corresponding to the length of the rasterized concatenated string in the longitudinal direction.

Through the rasterization process in S620, the CPU 11 develops the concatenated string represented by character codes into a bitmap image represented by an array of points (pixels). In the embodiment, the CPU 11 totals the number of pixels in the width direction required to display each character and space (blank) in order to calculate the display width Ws corresponding to the longitudinal length of the concatenated string.

Returning to FIG. 5, in S622 the CPU 11 determines whether the entire concatenated string can be displayed inside the breadcrumbs display area 34b. That is, the CPU 11 determines whether the display width Ws is less than or equal to a predetermined width W, where the predetermined width W is a value equivalent to the number of pixels in the breadcrumbs display area 34b along the horizontal direction (longitudinal direction) thereof that can be used for displaying text.

If the CPU 11 determines that the display width Ws is greater than the predetermined width W, i.e., that the entire concatenated string cannot fit inside the breadcrumbs display area 34b (S622: NO), in S624 the CPU 11 omits (deletes) the screen title of the j^{th} level (hierarchical level j) and the corresponding separating character from the concatenated string, in S626 increments j by “1”, and returns to S620. In other words, the CPU 11 removes the screen title for the screen positioned closest to the menu screen side with respect to the screen navigation path from the screen titles constituting the concatenated string.

The CPU 11 repeatedly removes screen titles in S624 until determining in S622 that the entire length of the concatenated string can fit inside the breadcrumbs display area 34b. In other words, the CPU 11 sequentially removes the leading (leftmost) screen title from the concatenated string to be displayed in the breadcrumbs display area 34b until the concatenated string no longer extends beyond the breadcrumbs display area 34b.

As described above, the display width Ws is calculated based on the rasterized concatenated string and, therefore, accurately reflects the actual length of the breadcrumbs that will be displayed in the breadcrumbs display area 34b. Accordingly, since the CPU 11 determines whether the entire concatenated string will fit inside the breadcrumbs display area 34b based on this display width Ws, the CPU 11 can display the maximum number of screen titles in the breadcrumbs display area 34b.

The CPU 11 determines that the entire concatenated string can fit inside the breadcrumbs display area 34b after repeating the above process (S622: YES), Then in S628 the CPU 11 sets the concatenated string as the breadcrumbs and displays the breadcrumbs in the breadcrumbs display area 34b. Note that if the value of the variable j is not 1, in S628 the CPU 11 displays the leading omission symbol 36 with the breadcrumbs. Then in S630 the CPU 11 sets a variable bottom_menu to the value f−1, that is, the value obtained by subtracting one from the hierarchical level f for the screen title currently displayed in the title display area 34a, i.e., the hierarchical level corresponding to the lowest level screen title in the breadcrumbs displayed in the breadcrumbs display area 34b. In S632 the CPU 11 sets a variable top_menu to the value assigned to the variable j, i.e., the hierarchical level corresponding to the topmost screen title in the breadcrumbs displayed in the breadcrumbs display area 34b.

In S634 the CPU 11 determines whether the user pressed a screen title included in the breadcrumbs. If a screen title has been pressed (S634: YES), in S636 the CPU 11 identifies the title ID of the pressed screen title from the breadcrumbs ID, displays the pressed screen title in the title display area 34a, and displays choices in the selection display area 32 for possible succeeding screens to the screen corresponding to the pressed screen title. Also in S636 the CPU 11 displays in the breadcrumbs display area 34b a breadcrumbs. Each screen title included in the breadcrumbs has the hierarchical levels higher than the hierarchical level of the pressed screen title.

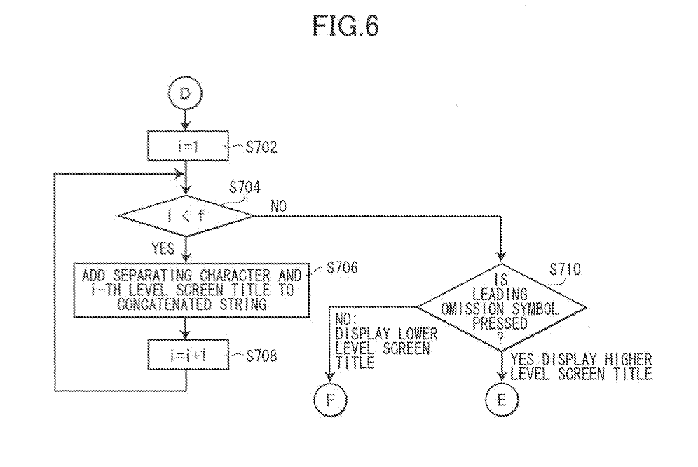

However, if a screen title has not been pressed (S634: NO), in S638 the CPU 11 determines whether one of the leading omission symbol 36 and the trailing omission symbol 38 has been pressed. If neither the leading omission symbol 36 nor the trailing omission symbol 38 has been pressed (S638: NO), the CPU 11 returns to S502 of FIG. 4. However, if one of the leading omission symbol 36 and the trailing omission symbol 38 has been pressed (S638: YES), the CPU 11 advances to S702 of FIG. 6.

Then, the CPU 11 executes steps S702-S708 for a process identical to the process in steps S610-S616 of FIG. 5, respectively.

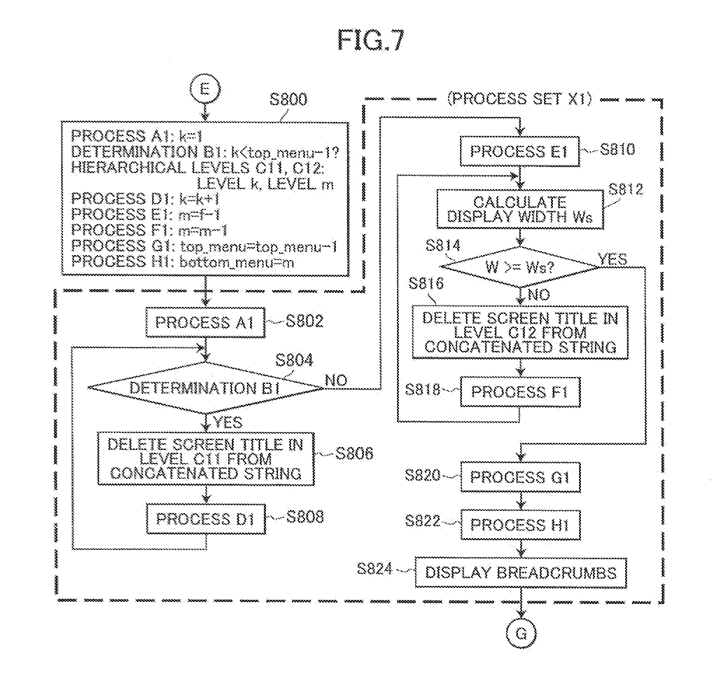

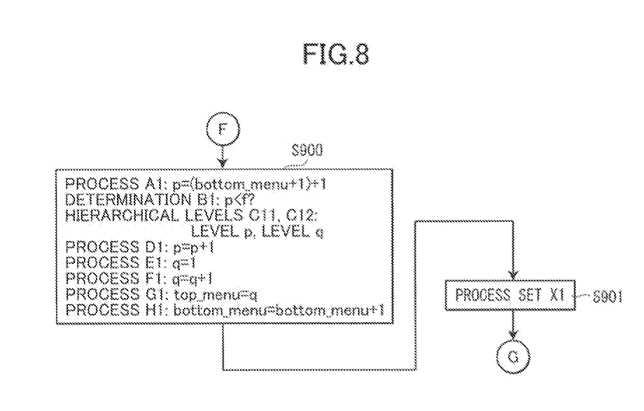

When the CPU 11 determines in S704 that i is greater than or equal to f (S704: NO), i.e., that the concatenated string including the screen titles having the hierarchical level from 1 to f−1 is created, in S710 the CPU 11 determines whether the region of the display determined to be pressed in S638 of FIG. 5 corresponds to the leading omission symbol 36. If so (S710: YES), then the CPU 11 advances to S800 of FIG. 7. On the other hand, if not (S710: NO), the CPU 11 advances to S900 of FIG. 8.

Next, the process executed by the CPU 11 upon determining that the leading omission symbol 36 has been pressed (S710: YES) will be described with reference to FIG. 7. In S800 at the beginning of this process, the CPU 11 defines processes and other data used in a process set X1. Specifically, the CPU 11 defines a process A1 as “set a variable k to 1”; a determination B1 as “determine whether the value of the variable k is smaller than the current value of the variable top_menu minus 1”; hierarchical levels C11 and C12 as “level k” and “level m”, respectively; a process D1 as “increment the value of the variable k by 1”; a process E1 as “set the variable m to the hierarchical level f minus 1”; a process F1 as “decrement the value of the variable m by 1”; a process G1 as “decrement the value of the variable top_menu by 1”; and a process H1 as “set the variable bottom_menu to the value of the variable m.”

Based on the definitions set in S800, the CPU 11 executes the process A1 in S802 and the determination B1 in S804. When a positive determination is made in S804 (S804: YES), in S806 the CPU 11 deletes the screen title corresponding to the screen in the hierarchical level indicated by the level C11 and the corresponding separating character from the concatenated string created in S706 of FIG. 6 and in S808 performs the process D1.

However, if a negative determination is made in S804 (S804: NO), in S810 the CPU 11 performs the process E1 and in S812 performs the same calculation in S620 of FIG. 5 and acquires the display width Ws. In S814 the CPU 11 performs the same determination described in S622 of FIG. 6. If the CPU 11 determines that the entire concatenated string will not fit in the breadcrumbs display area 34b (S814; NO), in S816 the CPU 11 omits (deletes) the screen title in hierarchical level C12 and the corresponding separating character from the concatenated string and in 5818 executes the process F1. However, if a positive determination is made in S814 (S814: YES), the CPU 11 executes the process G1 in 5820, executes the process H1 in S822, and in 5824 displays the concatenated string as breadcrumbs in the breadcrumbs display area 34b. In S824 the CPU 11 also displays the leading omission symbol 36 if one of more screen title deleted from the concatenated string through the process S802-S808. Further, the CPU 11 displays the trailing omission symbol 38 if one or more screen title is deleted from the concatenated string through the process S812-S818.

By executing processes S802-S808 according to the definitions established in S800, the CPU 11 adds the screen title corresponding to a screen one hierarchical level higher than the topmost screen in the currently displayed breadcrumbs (corresponding to the hierarchical level top_menu−1) and omits all screen titles for screens positioned hierarchically above the added screen title. Through this process, the CPU 11 can add, to the concatenated string, the screen title corresponding to the hierarchical level top_menu−1, that is, the screen title for the lowest hierarchical level among screen titles that is currently excluded from the breadcrumbs.

In S806 the screen title is deleted from the concatenated string in order to set the topmost screen title in the breadcrumbs to a screen title corresponding to a screen of the hierarchical level equivalent to the value of the variable top_menu minus one (one hierarchical level higher than the variable top_menu). Further, by executing processes S810-S824 according to the definitions established in S800, the CPU 11 can sequentially delete the screen title positioned in the bottommost hierarchical level one at a time in a direction toward higher levels from screen titles included in the concatenated string obtained as a result of the process S806.

Through the process in FIG. 7, the CPU 11 can display breadcrumbs in the breadcrumbs display area 34b that reflects a change from the state in FIG. 3(a) to the state shown in FIG. 3(b), for example. Further, the CPU 11 can delete screen titles from those currently included in the concatenated string in order beginning from the screen title in the bottommost level, i.e., in order from the screen title having the least importance to the user, until the breadcrumbs (the character string of concatenated screen titles) fits within the breadcrumbs display area 34b. Through the process in FIG. 7, the CPU 11 omits, from the concatenated string, at least one title included in the breadcrumbs displayed in the screen in which the leading omission symbol is pressed (see FIG. 3(a) as an example), and adds, to the concatenated string, at least one screen title that is omitted in the breadcrumbs displayed in the screen in which the leading omission symbol 36 is pressed (see FIG. 3(a) as an example). Further, in S816 the CPU 11 updates the concatenated string by omitting a screen title associated with a lowest hierarchical level among the screen titles included in the concatenated string.

As mentioned above, the processes in S802-S824 executed after defining the processes, determinations, and hierarchical levels A1-H1 in FIG. 7 will hereinafter be referred to as the process set X1.

Next, the process executed by the CPU 11 upon determining in S710 that the leading omission symbol 36 has not been pressed (i.e., that the trailing omission symbol 38 has been pressed; S710; NO) will be described with reference to FIG. 8. In S900 of this process, the CPU 11 defines the process A1 in the process X1 as “set a variable p to the current value of bottom_menu plus 2”; the determination B1 as “determine whether the value of the variable p is smaller than the hierarchical level f”; the hierarchical levels C11 and C12 as “level p” and “level q”, respectively; the process D1 as “increment the value of the variable p by 1”; the process E1 as “set the variable q to 1”; the process F1 as “increment the value of the variable q by 1”; the process G1 as “set the variable top_menu to the value of the variable q”; and the process H1 as “increment the value of the variable bottom_menu by 1.” In S901 the CPU 11 executes the process set X1 based on these definitions.

In S806 the screen title is omitted from the concatenated string in order to set the bottommost level of the screen title included in the concatenated string to the value of the variable bottom_menu plus 1 (one hierarchical level below the variable bottom_menu). Further, the CPU 11 can delete screen titles one at a time in order from the screen title positioned in the first hierarchical level in a direction toward lower hierarchical levels from screen titles included in the concatenated string obtained after performing the exclusions in S806.

Through the process shown in Fig, 8, the CPU 11 can display the concatenated string as breadcrumbs in the breadcrumbs display area 34b that reflect a change from the state shown in FIG. 3(b) to the state shown in FIG. 3(a), for example. Further, the CPU 11 can exclude screen titles from those currently included in the concatenated string in order from the topmost screen title, i.e., in order from the screen title having the least importance to the user until the concatenated string of screen titles can fit within the breadcrumbs display area 34b. That is, In S816 the CPU 11 omits a screen title associated with a highest hierarchical level among the screen titles included in the concatenated string. Further, the CPU 11 generates a concatenated string including a screen title associated with a highest hierarchical level among the screen titles that are omitted in the breadcrumbs shown in the screen (see FIG. 3(b) or FIG. 3(c)) in which the trailing omission symbol 38 is pressed.

### Second Embodiment

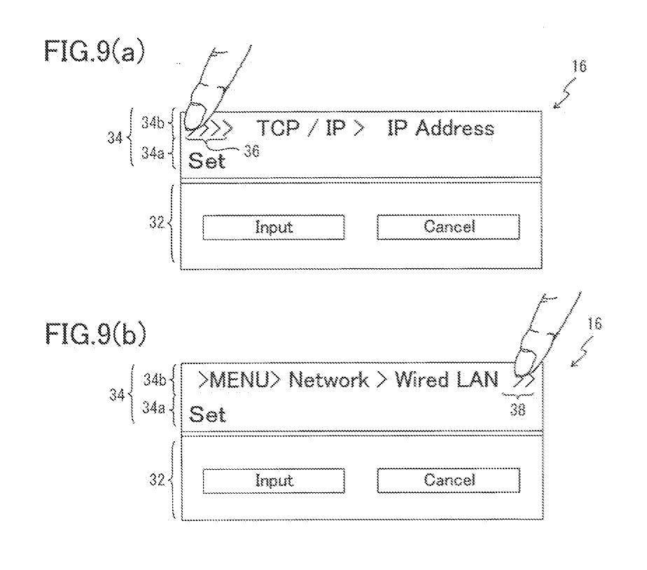

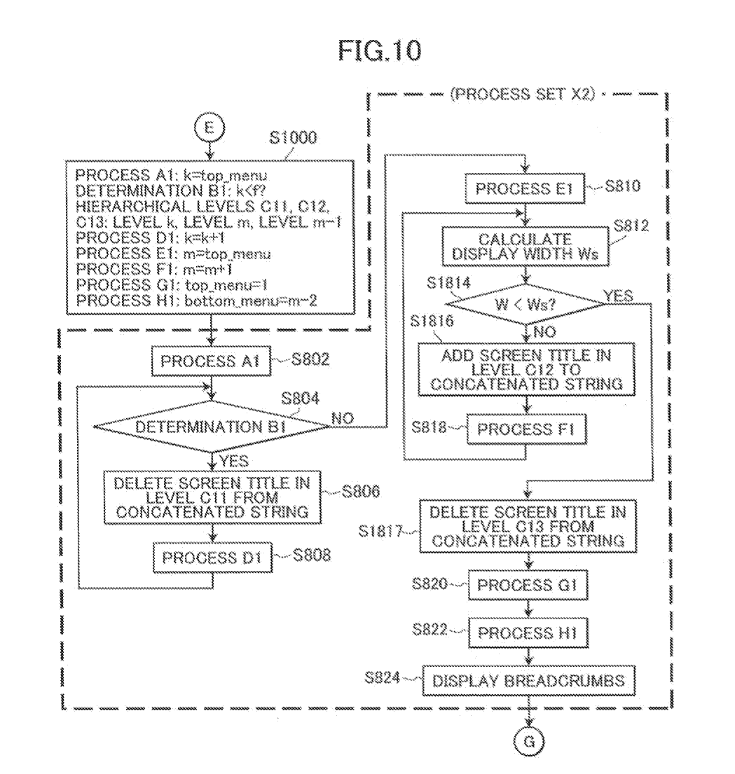

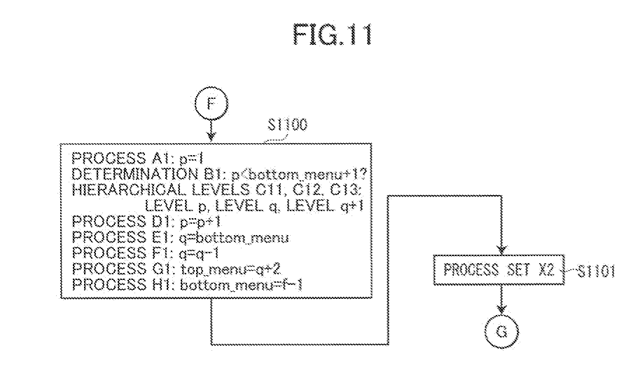

The MFP 1 according to a second embodiment will be described with reference to FIGS. 9(a)-11. The MFP 1 according to the second embodiment performs a process illustrated by the flowcharts in FIGS. 10 and 11 in place of the process illustrated by flowcharts in FIGS. 7 and 8 described in the first embodiment. The remaining configuration of the MFP 1 according to the second embodiment is identical to the MFP 1 according to the first embodiment.

First, screens displayed on the LCD 16 will be described with reference to FIGS. 9(a) and 9(b). In the example shown in FIGS. 9(a) and 9(b), the user has performed selections to navigate to the set screen belonging to the sixth level. Hence, the breadcrumbs for this example are “>Menu>Network>Wired LAN>TCP/IP>IP address.”

Since the entire character string constituting the breadcrumbs cannot be displayed in the breadcrumbs display area 34b, the MFP 1 omits the screen titles “Menu,” “Network,” and “Wired LAN,” as shown in FIG. 9(a).

If the user presses the leading omission symbol 36 in the LCD panel shown in FIG. 9(a), the MFP 1 displays the omitted screen titles “Menu,” “Network,” and “Wired LAN” in the breadcrumbs display area 34b in place of the screen titles “TCP/IP” and “IP address,” as shown in FIG. 9(b). Hence, the user can confirm all omitted screen titles by pressing the leading omission symbol 36.

If the user subsequently presses the trailing omission symbol 38 in the LCD panel shown in FIG. 9(b), the MFP 1 returns the display to the state shown in FIG. 9(a). Hence, the user can confirm all omitted screen titles by pressing the trailing omission symbol 38.

FIG. 10 is a flowchart showing a process in which the display changes from the state shown in FIG. 9(a) to the state shown in FIG. 9(b). The process shown in FIG. 10 is executed after the process shown in FIG. 6 in the first embodiment. That is, when the CPU 11 determines that the leading omission symbol 36 has been pressed (S710: YES), the CPU 11 proceeds to S1000 shown in FIG. 10. As shown in FIG. 10, in S1000 the CPU 11 defines processes and other data used in a process set X2. Specifically, the CPU 11 defines a process A1 as “set a variable k to the value of the variable top_menu”; a determination B1 as “determine whether the value of the variable k is smaller than the hierarchical level f”; hierarchical levels C11, C12, and C13 as “level k”, “level m”, and “level m−1”, respectively; a process D1 as “increment the value of the variable k by 1”; a process E1 as “set the variable m to the value of the variable top_menu”; a process F1 as “increment the value of the variable m by 1”; a process G1 as “set the variable top_menu to 1”; and a process H1 as “set the variable bottom_menu to the value of the variable m minus 2.”

Subsequently, based on the definitions set in S1000, the CPU 11 performs the process set X2 that is basically the same with the process set X1 shown in FIG. 7 except that the process set X2 performs steps S1814 and S1816 instead of the steps S814 and S816 in the process set X1 and also performs step S1817. That is, in S1814 the CPU 11 determines whether the display width Ws is greater than the predetermined width W that is equivalent to the number of pixels in the breadcrumbs display area 34b along the horizontal direction thereof When a negative determination is made, i.e., the entire concatenated string can be displayed in the breadcrumbs display area 34b (S1814: NO), in S1816 the CPU 11 adds the screen title of the hierarchical level C12 to the concatenated string and subsequently proceeds to S818. When a positive determination is made (S1814: YES), in S1817 the CPU 11 deletes the screen title corresponding to the screen in the hierarchical level indicated by the level C13 from the concatenated string, and proceeds to S820.

By performing the process shown in FIG. 10, the CPU 11 can display the concatenated string as breadcrumbs in the breadcrumbs display area 34b that reflects the change from the state shown in FIG. 9(a) to the state shown in FIG. 9(b), for example. Through the process shown in FIG. 10, the CPU 11 omits, from the concatenated string, all screen titles included in the breadcrumbs displayed in the screen in which the leading omission symbol 36 is pressed (see FIG. 9(a) as an example). In S1816, the CPU 11 updates the concatenated string by adding a screen title associated with a hierarchical level one level lower than a lowest hierarchical level among the screen title included in the concatenated string.

The processes in S802-S824 executed after defining the processes, determinations, and hierarchical levels A1-H1 in FIG. 10 will hereinafter be referred to as the process set X2.

Step S1100 shown in FIG. 11 is executed when the CPU 11 determines that the leading omission symbol 36 has not been pressed, that is, the CPU 11 determines that the trailing omission symbol 38 has been pressed (S710: NO). In S1100 the CPU 11 defines processes and other data used in the process set X2 executed in S1101. Specifically, the CPU 11 defines a process A1 as “set a variable p to 1”; a determination B1 as “determine whether the value of the variable p is smaller than the value of the variable bottom_menu plus 1”; hierarchical levels C11, C12, and C13 as “level p”, “level q”, and “level q+1”. respectively; a process D1 as “increment the value of the variable p by 1”; a process E1 as “set variable q to the value of the variable bottom_menu”; a process F1 as “decrement the value of the variable q by 1”; a process G1 as “set the variable top_menu to the value of the variable q plus 2”; and a process H1 as “set the variable bottom_menu to the hierarchical level f minus 1.”

Subsequently, based on the definitions set in S1100, in S1101 the CPU 11 performs the process set X2 shown in FIG. 10.

By performing the process shown in FIG. 11, the CPU 11 can display the concatenated string as breadcrumbs in the breadcrumbs display area 34b that reflects the change from the state shown in FIG. 9(b) to the state shown in FIG. 9(a), for example. The CPU 11 omits, from the concatenated string, all screen titles included in the breadcrumbs displayed in the screen in which the trailing omission symbol 38 is pressed (see FIG. 9(b) as an example). Specifically, in S1816 the CPU 11 adds, to the concatenated string, a screen title associated with a hierarchical level one level higher than a highest hierarchical level among the screen titles included in the concatenated string.

Through the processes described above in FIGS. 10 and 11, the CPU 11 deletes all screen titles currently included in the breadcrumbs and re-creates breadcrumbs that fit within the breadcrumbs display area 34b.

### Third Embodiment

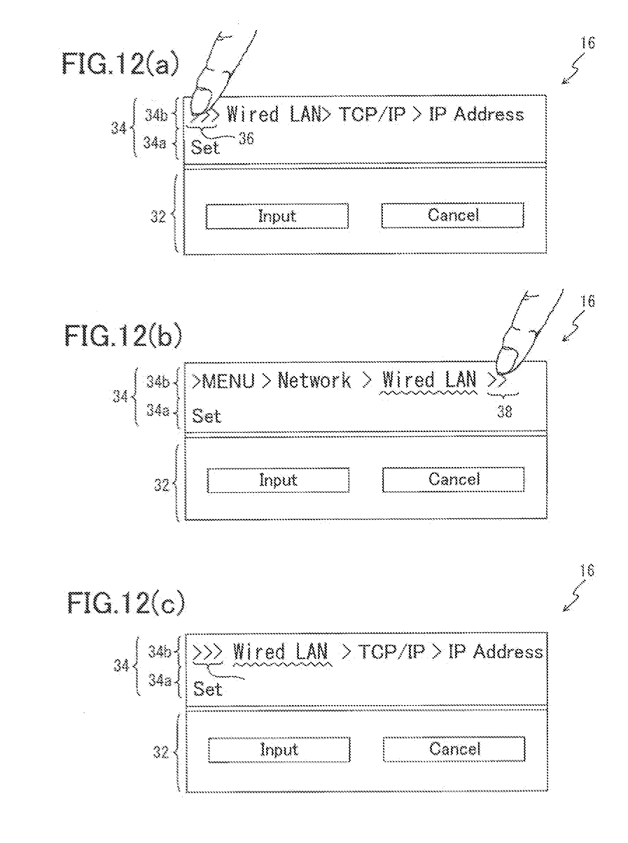

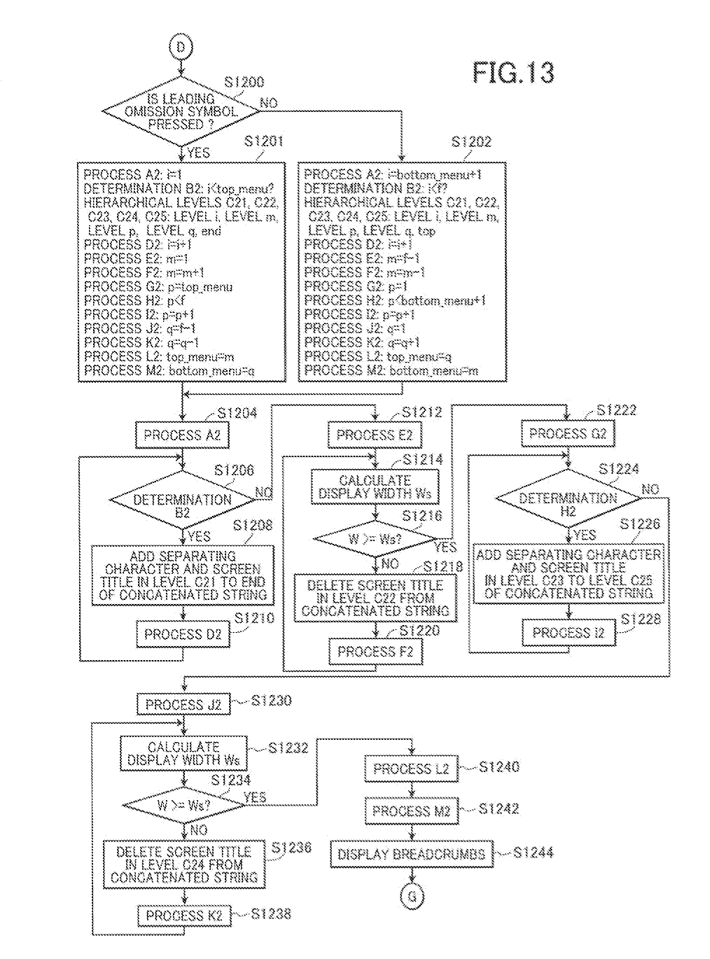

The MFP 1 according to a third embodiment will be described with reference to FIGS. 12(a)-13. The MFP 1 according to the third embodiment performs a process illustrated by the flowcharts in FIG. 13 in place of the process illustrated by flowcharts in FIGS. 6-8 described in the first embodiment. The remaining configuration of the MFP 1 according to the third embodiment is identical to the MFP 1 according to the first embodiment.

First, screens displayed on the LCD 16 will be described with reference to FIGS. 12(a)-12(c). In the example shown in FIGS. 12(a)-12(c), the user has selected screens to navigate to the set screen belonging in the sixth level. The breadcrumbs for this example indicates “>Menu>Network>Wired LAN>TCP/IP>IP address.”

Since the entire character string constituting the breadcrumbs cannot be displayed in the breadcrumbs display area 34b, the MFP 1 omits the screen titles “Menu” and “Network,” as shown in FIG. 12(a).

If the user presses the leading omission symbol 36 in the LCD panel shown in FIG. 12(a), the MFP 1 displays the omitted screen titles “Menu” and “Network” and adds the screen title “Wired LAN” already displayed in FIG. 12(a) to the remaining space in the breadcrumbs display area 34b, as shown in FIG. 12(b).

When the user presses the trailing omission symbol 38 in the LCD panel shown in FIG. 12(b), the MFP 1 returns the display to the state shown in FIG. 12(c) (equivalent to the state shown in FIG. 12(a)).

Next, the setup screen display process executed by the CPU 11 to implement the display changes shown in FIGS. 12(a)-12(c) will be described with reference to FIG. 13.

In S1200 at the beginning of the process, the CPU 11 determines whether a region of the LCD panel corresponding to the leading omission symbol 36 has been pressed in S638 of FIG. 5. The CPU 11 advances to S1201 if the leading omission symbol 36 has been pressed (S1200: YES) and advances to S1202 if the leading omission symbol 36 has not been pressed, that is, the trailing omission symbol 38 has been pressed (S1200: NO).

In S1201, the CPU 11 defines a process A2 as “set a variable i to 1”; a determination B2 as “determine whether the value of the variable i is smaller than the value of the variable top_menu; hierarchical levels C21, C22, C23, C24, and C25 as “level i”, “level m”, “level p”, “level q”, and “end”, respectively; a process D2 as “increment the value of the variable i by 1”; a process E2 as “set the variable m to 1”; a process F2 as “increment the value of the variable m by 1”; a process G2 as “set the variable p to the value of the variable top_menu”; a process H2 as “determine whether the value of the variable p is smaller than the hierarchical level 1”; a process 12 as “increment the value of the variable p by 1”, a process J2 as “set the variable q to the hierarchical level f minus 1”; the process K2 as “decrement the value of the variable q by 1”; a process L2 as “set the variable top_menu to the value of the variable m”; and a process M2 as “set the variable bottom_menu to the value of the variable q”.

In S1202, the CPU 11 defines the process A2 as “set a variable i to the value of the variable bottom_menu plus 1”; the determination B2 as “determine whether the value of the variable i is smaller than the hierarchical level f”; the hierarchical levels C21, C22, C23, C24, and C25 as “level i”, “level m”, “level p”, “level q”, and “top”, respectively; the process D2 as “increment the value of the variable i by 1”; the process E2 as “set the variable m to the hierarchical level f minus 1”; the process F2 as “decrement the value of the variable m by 1”; the process G2 as “set the variable p to 1”; the process H2 as “determine whether the variable p is smaller than the value of the variable bottom_menu plus 1”, the process L2 as “increment the value of the variable p by 1”, the process J2 as “set the variable q to 1”, the process K2 as “increment the value of the variable q by 1”, the process L2 as “set the variable top_menu to the value of the variable q”, and the process M2 as “set the variable bottom_menu to the value of the variable m”.

Based on the definitions established in S1201 or S1202, the CPU 11 executes the process A2 in S1204 and the determination B2 in S1206. If a positive determination is made in S1206 (S1206: YES), in S1208 the CPU 11 adds the separating character and the screen title corresponding to the screen in the hierarchical level indicated by hierarchical level C21 to the end of the concatenated string, and in S1210 executes the process D2.

However, if a negative determination is made in S1206 (S1206: NO), in S1212 the CPU 11 executes the process E2 and in S1214 calculates the display width Ws according to the same process described in S620 of FIG. 5. In S1216 the CPU 11 performs the same determination described in S622 of FIG. 5. If the entire concatenated string does not fit within the breadcrumbs display area 34b (S1216: NO), in S1218 the CPU 11 omits (deletes) the screen title in level C22 and the corresponding separating character from the concatenated string and in S1220 executes the process F2. However, if the entire concatenated string fits within the breadcrumbs display area 34b (S1216: YES), the CPU 11 executes the process G2 in S1222, and executes the determination H2 in S1224. If a positive determination is made (S1224: YES), in S1226 the CPU 11 adds the separating character and the screen title corresponding to the screen in the hierarchical level indicated by the level C23 to the concatenated string such that the added screen title is positioned at the level C25 in the concatenated string and in S1228 executes the process 12.

However, if a negative determination is made in S1224 (S1224: NO), in S1230 the CPU 11 executes the process J2 and in S1232 calculates the display width Ws according to the same process in S620 of FIG. 5. In S1234 the CPU 11 performs the same determination described in S622 of FIG. 5. If the entire concatenated string does not fit within the breadcrumbs display area 34b (S1234: NO), in S1236 the CPU 11 omits (deletes) the screen title in the level C24 from the concatenated string and in S1238 executes the process K2. However, if the entire concatenated string fits within the breadcrumbs display area 34b (S1234: YES), the CPU 11 executes the process L2 in S1240, executes the process M2 in S1242, and in S1244 displays the concatenated string as breadcrumbs in the breadcrumbs display area 34b. In S1244 the CPU 11 also displays the leading omission symbol 36 if the screen title having the hierarchical level 1 is omitted from the concatenated string through the process S1204-S1238. Further, the CPU 11 displays the trailing omission symbol 38 if the screen title having the hierarchical level f−1 is omitted from the concatenated string through the process S1204-S1238.

Through the process described in FIG. 13, the CPU 11 can determine whether there is any remaining space in the breadcrumbs display area 34b and adds previously displayed screen titles in the breadcrumbs that match the width of the remaining space.

More specifically, when executing S1204-S1244 based on the definitions established in S1201, the CPU 11 can display breadcrumbs in the breadcrumbs display area 34b that reflect a change from the state shown in FIG. 12(a) to the state shown in FIG. 12(b), for example. Through the processes executed in S1204-S1210, the CPU 11 concatenates screen titles from the menu screen to the screen one hierarchical level above the level indicated by the variable top_menu.

Further, when executing S1204-S1244 based on the definitions established in S1202, the CPU 11 can display breadcrumbs in the breadcrumbs display area 34b that reflect a change from the state shown in FIG. 12(b) to the state shown in FIG. 12(c), for example. By executing the processes in S1204-S1210, the CPU 11 concatenates screen titles from the screen one hierarchical level below the level indicated by the variable bottom_menu to the screen in the hierarchical level indicated by hierarchical level f−1.

Further, by executing S1222-S1228 based on the definitions established in either S1201 or S1202, the CPU 11 adds all screen titles included in the currently displayed breadcrumbs to the concatenated string created in S1218, and in S1230-S1238 deletes only those screen titles from the concatenated string that cannot fit within the breadcrumbs display area 34b.

### Fourth Embodiment

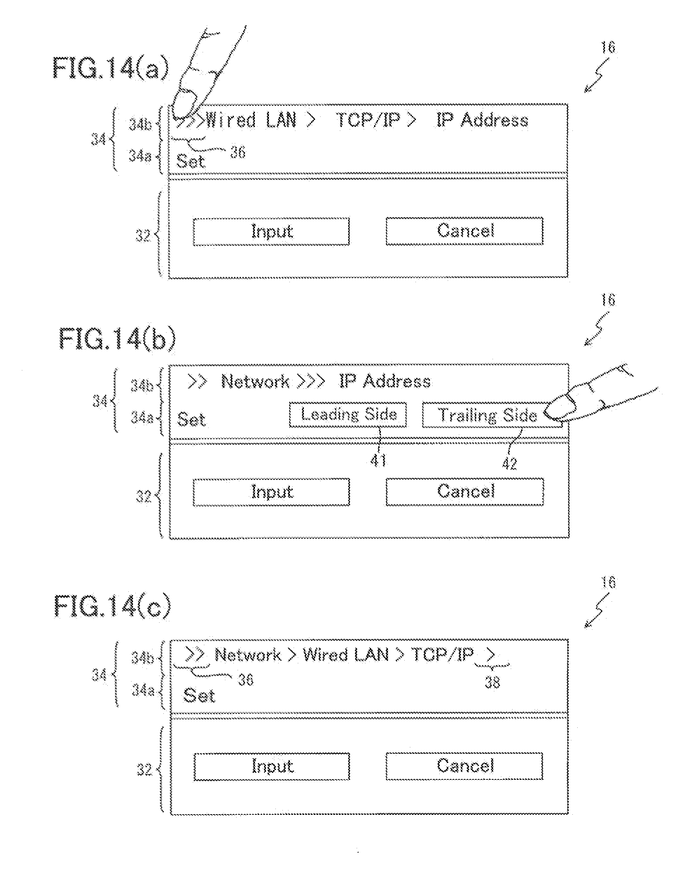

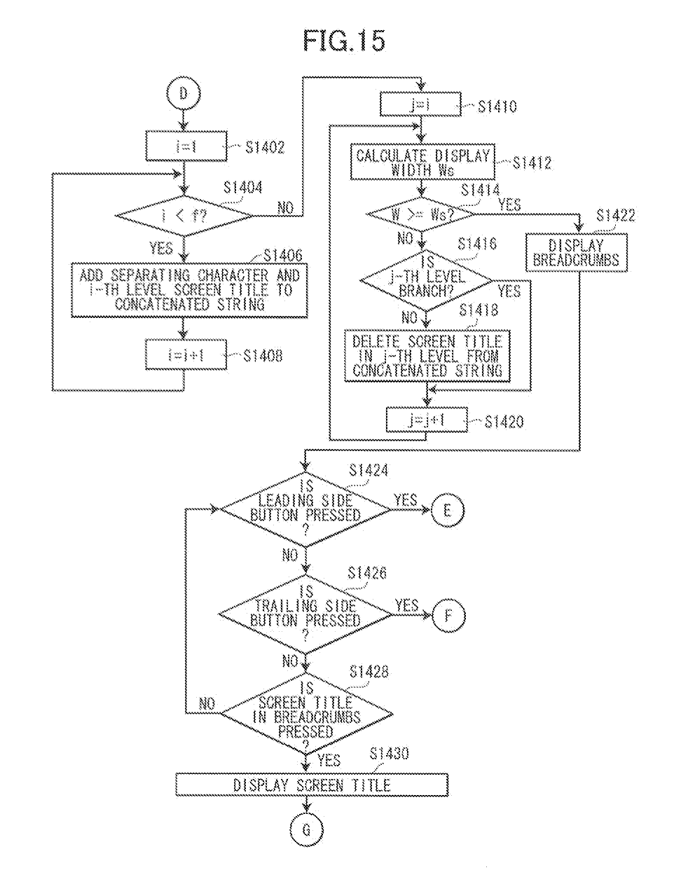

The MFP 1 according to a fourth embodiment will be described with reference to FIGS. 14(a)-15, The MFP 1 according to the fourth embodiment performs a process illustrated by the flowchart in FIG. 15 in place of the process illustrated by flowchart in FIG. 6 described in the first embodiment. The remaining configuration of the MFP 1 according to the fourth embodiment is identical to the MFP 1 according to the first embodiment.

In the fourth embodiment, branch data specified in the screen management table 12b is added to the breadcrumbs ID. For example, if the screen title currently displayed in the title display area 34a is for the set screen positioned in the sixth level in the screen management table 12b, the following data is saved as the breadcrumbs ID.

### [1]ID0[2]ID6:BRANCH[3]ID7[4]ID10[5]ID12:BRANCH[6]ID16

Next, the screens displayed on the LCD 16 will be described with reference to FIGS. 14(a)-14(c). In the example shown in FIGS. 14(a)-14(c), the user has selected screens to navigate to the set screen belonging in the sixth level. The breadcrumbs for this example are “>Menu>Network>Wired LAN>TCP/IP>IP address.”

Since the entire character string constituting the breadcrumbs cannot be displayed in the breadcrumbs display area 34b, the MFP 1 omits the screen titles “Menu” and “Network,” as shown in FIG. 14(a).

If the user presses the leading omission symbol 36 in the LCD panel shown in FIG. 14(a), the MFP 1 displays screen titles for screens between the first and fifth levels that constitute branches as shown in FIG. 14(b). In this case, the screen titles that constitute branches are “Network” and “IP address”. The MFP 1 also displays a Leading Side button 41 and a Trailing Side button 42 in the title display area 34a. By pressing the Trailing Side button 42, the user can return the display in the screen description area 34 to the state shown in FIG. 14(a).

If the user presses the Leading Side button 41 in the LCD panel shown in FIG. 14(b), the MFP 1 displays, in the breadcrumbs display area 34b, the screen title “Network”, “Wired LAN,” and “TCP/IP” in the breadcrumbs display area 34b as shown in FIG. 14(c), and omits, from the display, the screen title “IP address” displayed last in the breadcrumbs display area 34b illustrated in FIG. 14(a).

If the user presses the leading omission symbol 36 or the trailing omission symbol 38 in the LCD panel shown in FIG. 14(c), the MFP 1 returns the display in the screen description area 34 to the state shown in FIG. 14(b).

Hence, by pressing either the leading omission symbol 36 or the trailing omission symbol 38, the user can accurately learn information that is frequently needed, i.e., screen titles for screens constituting branches.

Next, a setup screen display process executed by the CPU 11 to implement the display changes illustrated in FIGS. 14(a)-14(c) will be described with reference to FIG. 15.

First, the CPU 11 performs processes S1402-1408 according to the same processes S610-S616 shown in FIG. 5.

When the CPU 11 determines in S1404 that i is greater than or equal to f (S1404: NO), indicating that the concatenated string including the screen titles having the hierarchical level from 1 to f−1 is created, in S1410 the CPU 11 sets a variable j to “1”. In S1412 the CPU 11 rasterizes the concatenated string and calculates the display width Ws corresponding to the length of the rasterized concatenated string in the longitudinal direction.

In S1414 the CPU 11 determines whether the entire concatenated string constituting the breadcrumbs can be displayed inside the breadcrumbs display area 34b. If the CPU 11 determines that the entire concatenated string cannot fit within the breadcrumbs display area 34b (S1414: NO), in S1416 the CPU 11 determines whether the j^{th} level is a branch based on the breadcrumbs ID. In other words, the CPU 11 determines whether a j^{th} level screen title included in the concatenated string is associated with the branch data in the screen management table 12b. If the j^{th} level is not a branch (S1416: NO), in S1418 the CPU 11 omits (deletes) the screen title in the j^{th} level from the concatenated string, in S1420 increments j by “1”, and returns to S1412.

On the other hand, if the CPU 11 determines in S1416 that the j^{th} level is a branch (S1416: YES), the CPU 11 skips S1418 and jumps to S1420. Thus, the CPU 11 repeatedly deletes a screen title in S1418 until determining in S1414 that the entire concatenated string can fit within the breadcrumbs display area 34b. Through this process, the CPU 11 can leave screen titles for screens constituting branches in the concatenated string, while deleting other screen titles one at a time from the concatenated string created in S1406 in order of higher to lower hierarchical levels beginning from the screen title in the first level.

Upon determining in S1414 that the concatenated string constituting the breadcrumbs fits within the breadcrumbs display area 34b (S1414: YES), in S1422 the CPU 11 displays the concatenated string as breadcrumbs in the breadcrumbs display area 34b and proceeds to S1424. In S1422 the CPU 11 also displays the leading omission symbol 36 if the screen title having the hierarchical level 1 is omitted from the concatenated string through the process S1412-S1420. Further, the CPU 11 displays the trailing omission symbol 38 if the screen title having the hierarchical level f−1 is omitted from the concatenated string through the process S1412-S1420.

In S1424 the CPU 11 determines whether the Leading Side button 41 is pressed. If a positive determination is made (S1424: YES), the CPU 11 proceeds to S800 shown in FIG. 7. If a negative determination is made (S1424: NO), in S1426 the CPU 11 determines whether the Trailing Side button 42 is pressed. If a positive determination is made (S1426: YES), the CPU 11 proceeds to S900 shown in FIG. 8. If a negative determination is made (S1426: NO), the CPU 11 proceeds to S1428. In S1428 the CPU 11 determines whether the user pressed a screen title included in the breadcrumbs. If so (S1428: YES), the CPU 11 proceeds to S1430. If a negative determination is made (S1428: NO), the CPU 11 returns to S1424. The process S1430 is the same as the process S636 of FIG. 5.

As described above, when the user presses one of the leading omission symbol 36 and the trailing omission symbol 38, the MFP 1 can re-display omitted screen titles positioned along the screen navigation path.

While the invention has been described in detail with reference to the embodiments thereof, it would be apparent to those skilled in the art that various changes and modifications may be made therein without departing from the spirit of the invention.

For example, the breadcrumbs may be displayed in multiple lines with line breaks therebetween. In this case, the predetermined width W compared with the display width Ws would be a value found by multiplying the horizontal width of the breadcrumbs display area 34b by the number of lines available for displaying the breadcrumbs. With this configuration, the display format of the breadcrumbs can be set to the user's preference.

Further, the screen title in the display within the title display area 34a for the currently displayed screen may also be included at the end of the breadcrumbs.

Further, the MFP 1 may be configured to determine whether the concatenated string fits within the breadcrumbs display area 34b based on the number of characters in the concatenated string.

Further, the menu screen itself may be positioned in one of a plurality of screen navigation paths branching off a screen positioned one level higher. In other words, the menu screen may not have the highest hierarchical level and branches from the screen having the hierarchical level higher than the hierarchical level of the menu screen.

Further, when the user presses either the leading omission symbol 36 or the trailing omission symbol 38, the MFP 1 may display a popup screen in the selection display area 32 or the screen description area 34 having a larger display area than the breadcrumbs display area 34b and may display all screen titles included in the breadcrumbs in the popup screen without omission.

Further, a pair of buttons having a wider area than the leading omission symbol 36 and the trailing omission symbol 38 may be provided in place of the leading omission symbol 36 and the trailing omission symbol 38 in the screen description area 34 and assigned the functions of the leading omission symbol 36 and the trailing omission symbol 38, respectively. With this configuration, the user can more easily press the buttons than the leading omission symbol 36 or the trailing omission symbol 38.

Further, rather than updating (i.e., changing the display format of) the breadcrumbs displayed in the breadcrumbs display area 34b, the MFP 1 may maintain the same display when the user presses the screen title “Network”, for example, in the described in the first embodiment. With this configuration, the user can confirm the screen navigation history and can more smoothly navigate to different screen titles in the breadcrumbs, even after pressing the screen title “Network.”

Further, in the fourth embodiment described above, branch data may be added to all hierarchical levels in the screen management table 12b. In this case, a character string such as “Normal” could be added to levels that do not constitute a branch.

In the embodiments described above, the screen title for the currently displayed screen is not included in the breadcrumbs. That is, the end of the breadcrumbs includes the screen title of the screen belonging to a level one hierarchical level above the currently displayed screen. However, the screen title for the currently displayed screen may also be included at the end of the breadcrumbs and displayed therewith. For example, when the screen “TCP/IP” is displayed currently in accordance with the screen management table 12b, the CPU 11 may display the concatenated string “Menu>Network>Wired LAN>TCP/IP” on the breadcrumbs display area 34b.

In the embodiments described above, the concatenated string includes the titles corresponding to all screens which are positioned in a part of the navigation path from menu screen to the current display screen. However, the concatenated string may include the titles each corresponding to a screen which is positioned at a part of the navigation path from the menu screen to the current display screen. For example, when the screen “TCP/IP” is displayed currently in accordance with the screen management table 12b, the CPU 11 may create the concatenated string “MENU >Wired LAN >TCP/IP” excluding “Network”. In this case, in S624, S816, S1218, and S1232, the MFP 1 deletes screen titles in an order from a screen title having the highest level among the screen titles included in the concatenated string, to a screen title having a lower level. Alternatively, the MFP 1 may delete screen titles in an order from the title string of an arbitrary selected level included in the concatenated string to the screen title having a lower level than the arbitrary selected level.

In the embodiments, the separating character (>) is used as the symbol (the leading omission symbol 36 and the trailing omission symbol 38) indicating that the screen title is excluded from the breadcrumbs. However, other symbol may be used as the symbol indicating that the screen title is excluded.

In the embodiments, the entire title of screen (for example “MENU”) is the screen title. In other words, only one screen title is assigned with one screen in the screen management table 12b. However, a plurality of screen titles may be assigned with one screen in the screen management table 12b. That is, the screen management table 12b stores the plurality of screen titles in association with the one title ID. For example, for the screen corresponding to the title ID ID00 (“Menu” screen), the screen management table 12b stores four screen titles “M”, “E”, “N”, and “U” and for the screen corresponding the title ID ID12 (“IP Address” screen), the screen management table 12b stores two screen titles “IP” and “Address”. In this case, for example, the breadcrumbs includes the screen title “M” instead of the screen title “MENU”. That is, the part of the entire title of the screen (“ENU”) is excluded from the breadcrumbs. Or, for example, the breadcrumbs includes the screen title “Address” instead of the screen title “IP Address”. That is, the part of the title of the entire screen (“IP”) is excluded from the breadcrumbs.

What is claimed is:

1. A display device comprising:
a display unit including a first portion and a second portion;
a display control unit that is configured to display one of a plurality of screen images on the first portion, the plurality of screen images including a base screen image and being arranged hierarchically from the base screen image, the display control unit changing a screen image to display from one to another of the plurality of screen images along a screen navigation path starting from the base screen image based on screen navigation data, the screen navigation data indicating relationships between the screen images;
a storing unit that stores a plurality of title strings, each title string indicating one of the plurality of screen images;
a navigation string generating unit that is configured to generate a navigation string including the title strings each corresponding to a screen image which is positioned in a part of the screen navigation path from the base screen image to a current screen image that is displayed on the first portion currently;
a first navigation string display unit that is configured to control the display unit to display the navigation string in the second portion;
a first determining unit that is configured to determine whether any title string included in the navigation string displayed in the second portion is selected; and
a selected screen display unit that, when the first determining unit determines that a title string is selected, is configured to control the display unit to display a screen image specified by the selected title string in the first portion.

2. The display device according to claim 1, wherein when the selected screen display unit controls the display unit to display the screen image specified by the selected title string, the first navigation string display unit controls the display unit to continue to display the navigation string without change

3. The display device according to claim 1, wherein each of the plurality of title strings is associated with a hierarchical level, a title string corresponding to the base screen image being associated with a highest hierarchical level among the plurality of screen images,
wherein the first navigation string display unit is configured to control the display unit to replace the navigation string to a different string, each title string included in the different string being associated with a hierarchical level higher than a hierarchical level associated with the selected title string.

4. The display device according to claim 1, wherein each of the plurality of title strings is associated with a hierarchical level, a title string corresponding to the base screen image being associated with a highest hierarchical level among the plurality of screen images,
wherein the navigation string generating unit comprises:
a concatenated string generating unit that is configured to generate a concatenated string including the title strings each corresponding to a screen image which is positioned in a part of the screen navigation path from the base screen image to a current screen image that is displayed on the first portion currently; and
a first omitting unit that, when the concatenated string is too large to be displayed entirely on the second portion, is configured to generate a first omitted string by omitting, from the concatenated string, at least one title string corresponding to at least one screen image which is positioned in a part of the screen navigation path from the base screen image to an arbitrary screen image having a lower level than a level of the base screen image,
wherein the first navigation string display unit comprises a second navigation display unit that is configured to control the display unit to display the first omitted string, as the navigation string, with a first symbol indicating that the at least one title string is omitted in the second portion,
wherein the navigation string generating unit further comprises a second determining unit that is configured to determine whether the first symbol is selected; and
a second omitting unit that, when the second determining unit determines that the first symbol is selected, is configured to generate a second omitted string, as the navigation string, by omitting, from the concatenated string, at least one title string included in the first omitted string, the second omitted string including at least one title string that is omitted by the first omitting unit,
wherein the first navigation string display unit further comprises a third navigation display unit that is configured to control the display unit to display the second omitted string, as the navigation string, with a second symbol indicating that the at least one title string included in the first omitted string is omitted.

5. The display device according to claim 4, wherein the second omitted string includes a title string that is omitted from the first omitted string and that is associated with a lowest hierarchical level among the title strings omitted from the first omitted string.

6. The display device according to claim 5, wherein the navigation string generating unit further comprises:
a third determining unit that is configured to determine whether the second omitted string fits in the second portion; and
a third omitting unit that is configured to update the second omitted string by omitting a title string associated with a lowest hierarchical level among the title strings included in the second omitted string when the third determining unit determines that the second omitted string is too large to be displayed entirely on the second portion,
wherein the third determining unit is configured to perform the determination each time the third omitting unit updates the second omitted string,
wherein the third omitting unit is configured to repeatedly update the second omitted string until the third determining unit determines that the second omitted string fits in the second portion.

7. The display device according to claim 6, wherein the third determining unit includes a calculating unit that is configured to calculate a width of the second omitted string in a direction in which each title string in the second omitted string is arranged, and the third determining unit is configured to determine that the second omitted string fits in the second portion when the width is smaller than or equal to a predetermined value.

8. The display device according to claim 5, wherein when the second determining unit determines that the first symbol is selected, the second omitting unit is configured to generate the second omitted string by omitting, from the concatenated string, all title strings included in the first omitted string.

9. The display device according to claim 8, wherein the navigation string generating unit further comprises:
a third determining unit that is configured to determine whether the second omitted string fits in the second portion; and
a first adding unit that is configured to update the second omitted string by adding, to the second omitted string, a title string associated with a hierarchical level one level lower than a lowest hierarchical level among the title strings included in the second omitted string when the third determining unit determines that the second omitted string fits in the second portion,
wherein the third determining unit is configured to perform the determination each time the first adding unit updates the second omitted string,
wherein the first adding unit is configured to repeatedly update the second omitted string until the third determining unit determines that the second omitted string is too large to be displayed entirely on the second portion.

10. The display device according to claim 9, wherein the third determining unit includes a calculating unit that is configured to calculate a width of the second omitted string in a direction in which each title string in the second omitted string is arranged, the third determining unit being configured to determine that the second omitted string fits in the second portion when the width is smaller than or equal to a predetermined value.

11. The display device according to claim 5, wherein the navigation string generating unit further comprises a fourth determining unit that is configured to determine whether the second symbol displayed in the second portion is selected, wherein after the fourth determining unit determines that the second symbol is selected, the first omitting unit is configured to newly generate a first omitted string including a title string being associated with a highest hierarchical level among title strings that are omitted by the second omitting unit.

12. The display device according to claim 11, wherein the navigation string generating unit further comprises:
a fifth determining unit that is configured to determine whether the newly generated first omitted string fits in the second portion; and
a fourth omitting unit that is configured to update the newly generated first omitted string by omitting a title string being associated with a highest hierarchical level among the title strings included in the newly generated first omitted string when the fifth determining unit determines that the newly generated first omitted string is too large to be displayed entirely on the second portion,
wherein the fifth determining unit is configured to perform the determination each time the fourth omitting unit updates the newly generated first omitted string,
wherein the fourth omitting unit is configured to repeatedly update the newly generated first omitted string until the fifth determining unit determines that the first omitted string fits in the second portion.

13. The display device according to claim 12, wherein the fifth determining unit includes a calculating unit that is configured to calculate a width of the newly generated first omitted string in a direction in which each title string in the newly generated first omitted string is arranged, the fifth determining unit is configured to determine that the newly generated first omitted string fits in the second portion when the width is smaller than or equal to a predetermined value.

14. The display device according to claim 11, wherein the first omitting unit is configured to newly generate the first omitted string by omitting, from the concatenated string, all title strings included in the second omitted string,

15. The display device according to claim 14, wherein the navigation string generating unit further comprises:
a fifth determining unit that is configured to determine whether the newly generated first omitted string fits in the second portion; and
a second adding unit that is configured to update the newly generated first omitted string by adding, to the newly generated first omitted string, a title string being associated with a hierarchical level one level higher than a highest hierarchical level among the title strings included in the newly generated first omitted string when the fifth determining unit determines that the newly generated first omitted string fits in the second portion,
wherein the fifth determining unit is configured to perform the determination each time the second adding unit updates the newly generated first omitted string,
wherein the second adding unit is configured to repeatedly update the first omitted string until the fifth determining unit determines that the first omitted string is too large to be displayed entirely the second portion.

16. The display device according to claim 15, wherein the fifth determining unit includes a calculating unit that is configured to calculate a width of the newly generated first omitted string in a direction in which each title string in the newly generated first omitted string is arranged, the fifth determining unit is configured to determine that the newly generated first omitted string fits in the second portion when the width is smaller than or equal to a predetermined value.

17. The display device according to claim 4, wherein the storing unit further stores branch data indicating that a title string associated with the branch data corresponds to a screen image constituting one of decision branch, the decision branch being configured to be selected in a screen image corresponding to a title string associated with a hierarchical level one level higher than the screen image constituting the decision branch,
the display device further comprising a branch determining unit that is configured to determine whether a title string included in the concatenated string is associated with the branch data,
wherein the second omitting unit is configured to generate the second omitted string by omitting a title string not associated with the branch data from the concatenated string.

18. The display device according to claim 4, wherein the storing unit further stores branch data indicating that a title string associated with the branch data corresponds to a screen image constituting one of decision branch, the decision branch being configured to be selected in a screen image corresponding to a title string associated with a hierarchical level one level higher than a hierarchical level of the screen image constituting the decision branch,
the display device further comprising a branch determining unit that is configured to determine whether a title string included in the concatenated string is associated with the branch data,
wherein the first omitting unit is configured to generate the first omitted string by omitting a title string not associated with the branch data from the concatenated string.
